(19) United States
(12) Patent Application Publication
(10) Pub. No.: US 2010/0120296 A1
(43) Pub. Date: May 13, 2010

(54) Mechanism For Telecommunication Connector

(76) Inventor: Ting-Pan LIU, Hsinchuang City (TW)

Correspondence Address: IPFortune LLC, 1629 K Street N.W., Suite 300, Washington, DC, 20006, US

(21) Appl. No.: 12/480,639

(22) Filed: Jun. 8, 2009

(30) Foreign Application Priority Data
Nov. 10, 2008 (TW) 97220087

(51) Int. Cl. H01R 9/22

(52) U.S. Cl. 439/708

(57) ABSTRACT

An improved mechanism for telecommunication connector including a grounding body, a rear end insulator, a center pin, and other components is provided. The grounding body is a hollow housing with a through hole along its centerline. A center pin is fixed on the center of rear insulator, and the rear insulator with the center pin is installed onto the rear end opening of the through hole of the grounding body. The installed center pin will be on the centerline of the through hole of the grounding body, and a segment of it is exposed outside the assembled connector for connecting with the circuit board or other transmission objects.

### BACKGROUND OF THE INVENTION

1. Field of the Invention

The present invention relates to an improved mechanism for telecommunication connector. Particularly, the present invention relates to a mechanism for fixing a center pin of a telecommunication connector.

2. Description of Related Art

Referring to FIG. 1 to FIG. 3, a telecommunication connector usually includes a grounding body 1a, a center pin 2a, an rear end insulator 3a, and other components (not shown herein), for example, a center pin clip, an optional inner circular spring clip, a front tip insulator and so on. The grounding body 1a and the center pin 2a are made of high conductive material. The grounding body 1a is a hollow housing typically of a cylindrical shape (but not necessarily in all cases) at the front end. The center pin 2a is installed at the center of the rear end insulator 3, and the assembled rear end insulator 3 with center pin 2a is installed at the central rear end hole of the grounding body 1a.

Because of the mechanical conflict due to the diameter at the rear end portion of the through hole of the grounding body 1a is smaller than the diameter of the rear end insulator 3a, the rear end insulator 3a holding center pin 2a is fixed tightly in the grounding body 1a. The center pin 2a is fixed tightly in the grounding body 1a as well. The center pin 2a is coaxial to the inner wall surface of the grounding body 1a. The exposed portion of the pin 2a can be bent if necessary.

Further, the conventional technique is relatively cost inefficient for a manufacturer to control the mechanical precision of the inner diameter of a grounding body 1a and the outer diameter of rear end insulator 3a. The rear end insulator 3a sometimes may be too tight to be installed into the grounding body 1a.

Hence, when the outer diameter is too tight, either insulator 3a or the grounding body 1a should be reworked or repaired, otherwise the assembly of the telecommunication connector may fail. Either way the cost is increased but the good output rate is decreased. On the contrary, when the outer diameter is too small, the center pin 2a may become loose and can be rotated or swayed in the grounding body 1a.

In addition, the center pin 2a may not be firmly fixed in the grounding body 1a due to other factors such as the storage environment, climate changes, shaking and collisions during shipping and handling, secondary processes, and etc. Sometimes the defective rate of loose center pin increases after the soldering and reflow processes of installing the assembled RF can onto the circuit board.

Furthermore, the temperature or the hot airflow in the environment may slightly resize the precise diameter of the rear end insulator 3a or the precise diameter of the through hole of the grounding body 1a. Such conditions will also affect the coaxial requirement of the center pin 2a and the through hole of the grounding body 1a. Sometimes the center pin 2a may be shifted asides from the predetermined location or may fall off the assembled connector when the center pin 2a is hit or pushed. As a result, failure or downgrade of telecommunication capability (or quality) can be expected.

Thus, there are many drawbacks of the mechanism for telecommunication connector of the prior art. When the center pin 2a is loose, the position or the angle of the center pin 2a needs to be adjusted manually before being adapted onto a circuit board (sometimes the telecommunication connector would be adapted onto the circuit board with a RF can assembled). Such a manual adjustment cannot ensure the reworked or repaired center pin 2a to provide the best performance.

Furthermore, the position or the angle of a loose center pin 2a adjusted manually could be shifted from the position of best performance. The center pin 2a on the rear insulator 3a may be even departed from the connector during secondary processes, such as shipping and handling, soldering or reflow processes, and etc. During reflow process, the minor vibration of reflow machine, the heat flow in the reflow chambers, the design of carrying belt and fixtures, and the other factors in the reflow process are all possible causes to change the manually adjusted position of the center pin 2a. The center pin 2a could be shifted or swayed again. The signal quality may be weakened or even totally lost due to the swayed or shifted center pin 2a.

Moreover, a loose center pin 2a will result in bad connection to the center pin clip. Such a bad connection will weaken signals or even fail the telecommunication. Unexpected high heat may also be generated, and subsequently result in damages on the finishing machine or even injuries to the consumers.

A loosely assembled center pin 2a may fall off from the center pin clip after some plug-in and pull-off operations. When the assembled center pin 2a falls off, bad consequences including product failure, customer or consumer complaints, company reputation and goodwill impairment, and even costly product recall or legal suit may happen.

### SUMMARY OF THE INVENTION

One particular aspect of the present invention is to provide an improved mechanism for a telecommunication connector to overcome the problem of loose center pin.

In order to achieve the above-mentioned improvements, the present invention provides an improved mechanism applied to a telecommunication connector. The mechanism includes a grounding body, a center pin, a rear end insulator, and other components (not shown herein). The grounding body is composed of a hollow housing with a through hole. Either opening of the through hole is round but may not be of the same diameter.

Specifically, the center pin is fixed at the center of the rear end insulator. The rear end insulator holding the center pin is installed into the round hole at the rear end of the grounding body. A part of the center pin is exposed outside the rear end of grounding body for the connection to the circuit board or the target component. The exposed portion of the center pin can be bent accordingly if necessary.

Another aspect of the present invention is that the diameter of the round hole at the rear end of grounding body and the diameter of the rear end insulator function as a preliminary mechanism to hold the rear end insulator tightly so that the center pin will be tightly held in the grounding body too. An annular or geometric groove is made on the rear end surface of the grounding body and surrounds the center hole. The groove is provided for further tightening the center pin with a separated but may not be secondary process.

In order to achieve the improvements mentioned above, the present invention provides an improved mechanism applied to a telecommunication connector. The mechanism includes a grounding body, a center pin, a rear end insulator, and other components (not shown herein). The grounding body is composed of a hollow housing with a through hole. Either opening of the through hole is round but may not be of the same diameter. The center pin is fixed at the center of the rear end insulator. The rear end insulator holding the center pin is installed into the round hole at the rear end of the grounding body. A part of the center pin is exposed outside the rear end of grounding body for the connection to the circuit board or other components. The exposed portion of the center pin can be bent accordingly if necessary.

The diameter of round hole at the rear end of grounding body and the diameter of the rear end insulator function as a preliminary mechanism to hold the rear end insulator tightly so that the center pin will be tightly held in the grounding body too. At least one tiny indent nearby the center hole is made on the rear end surface of grounding body. The tiny indent (or indents) is provided to enhance the tightness of the center in the grounding body pin with a separated but not necessarily secondary process.

The diameter of round hole at the rear end of grounding body and the diameter of the rear end insulator function as a preliminary mechanism to hold the rear end insulator tightly so that the center pin will be tightly held in the grounding body too. The present invention also provides another mechanism for the improvements mentions above. A plug is made on the rear end insulator and is extended from the main body of the rear end insulator. A corresponding blind hole is on the rear end surface of the grounding body with certain distance from the center round hole.

The present invention provides many advantages. Some of them are listed as follows.

1. Overcome the problems of loose center pin on the telecommunication connector.

2. Reduce the precision requirements, process and quality control costs, and tooling maintenance costs of manufacturing grounding bodies, center pins, rear end insulators, and other components. Thus, the overall production costs can be reduced but the capacity and the good output will be increased.

3. The costs of manually sorting and adjustment prior to SMT (surface mounting technologies) process can be saved. The good output rate and the quantity of total throughput will be increased.

Other advantages and features of the invention as well as the associated derived implementations and applications will be apparent from the following description, drawings, and claims. It is to be understood that both the mentioned general description and the following detailed demonstrative description are for illustration purpose of the invention claimed instead of limiting the ranges of the claimed invention.

### BRIEF DESCRIPTION OF THE DRAWINGS

The various objects and advantages of the present invention will be more readily understood from the following detailed description and the attached drawings.

FIG. 1 is a schematic side view of a telecommunication connector of prior art.

FIG. 2 is a schematic rear view of a telecommunication connector of prior art.

FIG. 3 is a schematic profile of prior art.

FIG. 4 is a schematic profile of an improved mechanism of a telecommunication connector according to the first preferred embodiment of the present invention.

FIG. 5 is the detailed description of A in FIG. 4.

FIG. 6 is a schematic side view of an improved mechanism of a telecommunication connector according to the first preferred embodiment of the present invention.

FIG. 7 is a schematic rear view of an improved mechanism a telecommunication connector according to the first preferred embodiment of the present invention.

FIG. 8 is a schematic profile view of an improved mechanism of a telecommunication connector according to the first preferred embodiment of the present invention.

FIG. 9 is a schematic side view of the improved mechanisms of telecommunication connectors according to the second preferred embodiments of the present invention.

FIG. 10 is a schematic rear view of an improved mechanism of a telecommunication connector according to the second preferred embodiment of the present invention with common round indent(s).

FIG. 11 is a schematic rear view of an improved mechanism of a telecommunication connector according to the second preferred embodiment of the present invention with different indent (arch, for instance) design.

FIG. 12 is a schematic profile of an improved mechanism of a telecommunication connector according to the second preferred embodiments of the present invention.

FIG. 13 is a schematic rear view of an improved mechanism of a telecommunication connector according to the third preferred embodiment of the present invention.

FIG. 14 is a detailed description of A in FIG. 13.

FIG. 15 is a schematic profile of an improved mechanism of a telecommunication connector according to the third preferred embodiment of the present invention.

FIG. 16 is detailed description of A in FIG. 15.

FIG. 17 is a schematic rear view of an improved mechanism a telecommunication connector according to the fourth preferred embodiment of the present invention.

FIG. 18 is a schematic profile of an improved mechanism a telecommunication connector according to the fourth preferred embodiment of the present invention.

FIG. 19 is a schematic rear view of an improved mechanism of a telecommunication connector according to the fifth preferred embodiment of the present invention; and

FIG. 20 is a schematic profile of an improved mechanism of a telecommunication connector according to the fifth preferred embodiment of the present invention.

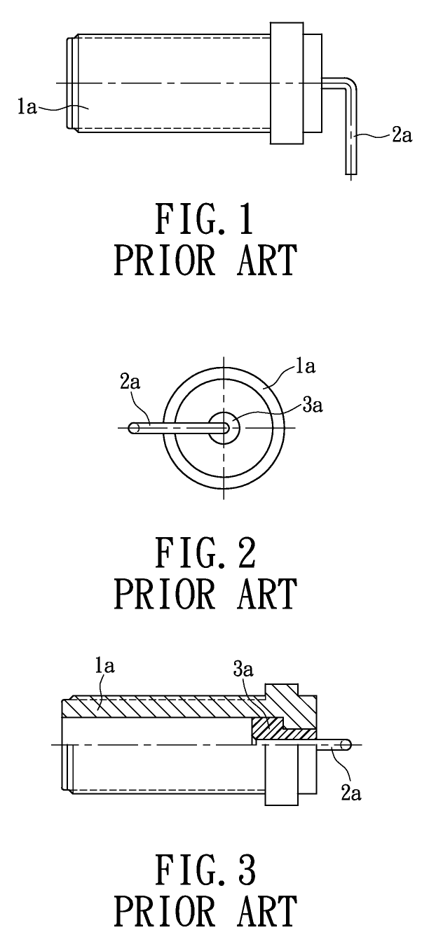

### DETAILED DESCRIPTION OF THE PREFERRED EMBODIMENTS

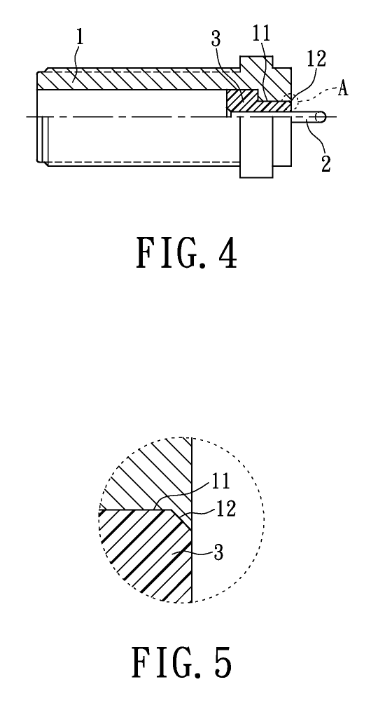

Referring to FIG. 4 to FIG. 8, the present invention provides an improved mechanism to a telecommunication connector. The telecommunication connector includes a grounding body 1, a center pin 2, a rear end insulator 3, and other components (not shown herein). The grounding body 1 and the center pin 2 are made of high-conductive material. The grounding body 1 is composed of a hollow housing with a through hole.

Specifically, either opening of the through hole is round but may not necessarily be of the same diameter. The round hole 11 at the rear end is installed with a rear end insulator 3 holding the center pin 2 tightly at the center. Because of the mechanical conflict due to the diameter of the rear round hole 11 of the grounding body 1 is slightly smaller than the diameter of the rear end insulator 3, the rear end insulator 3 holding center pin 2 at the center is tightly fixed into the rear end opening of grounding body 1.

Thus, the center pin 2 is tightly fixed and coaxially with the inner surface of the through hole in the grounding body 1. The exposed portion of the center pin 2 can be bent, if necessary. The telecommunication connector also includes other components (not shown herein), such as a center pin clip, an optional inner circular spring clip, a front tip insulator, and so on.

Further, a preferred annular fastening method is utilized. After the telecommunication connector is installed onto the RF can (also known as shielding case, shielding frame, shielding cover, enclosure, tuner frame, and so forth) or after the subsequent secondary processes (such as soldering and/or other processes), an annular or other geometric indent groove 13 is formed on the rear end surface of the grounding body 1 around the rear round hole 11 to enhance the mechanism 12 with punching or pressing processes. Such punching or pressing processes would slightly but evenly reduce the diameter of the end opening of mechanism 12.

Therefore, the rear end insulator 3 is firmly fixed in the rear round hole 11 of the grounding body 1 by the enhanced mechanism 12, and the center pin 2 is firmly fixed as well in the grounding body 1 by the rear end insulator 3. Various materials and designs of the grounding body 1 and the rear end insulator 3 can be made. Thereby, the position and depth of the indent groove 13, the pressure of punching, extruding or pressing processes, and all related process and fastening factors can be adjusted according to the different materials and designs. The indent groove 13 can be formed during the forming processes of the grounding body 1 or before the complete connector is assembled.

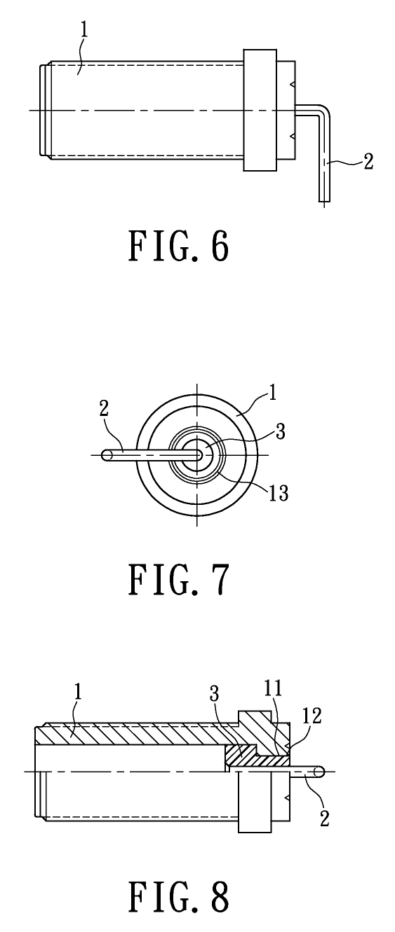

Now referring to FIG. 6 to FIG. 8, an indent groove 13 of annularity or other geometric shape can be formed on the rear end surface of the grounding body 1 during the manufacturing processes of the grounding body 1. Such a practice would ease the enhancing process of the mechanism 12. Groove 13 can be changed to other geometric shape according to materials and designs of the grounding body 1 and the rear end insulator 3. The design of groove 13 can be changed according to the telecommunication requirements as well.

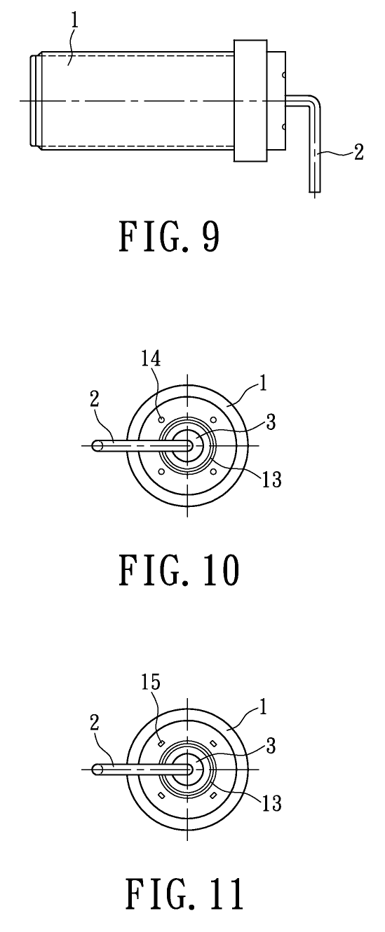

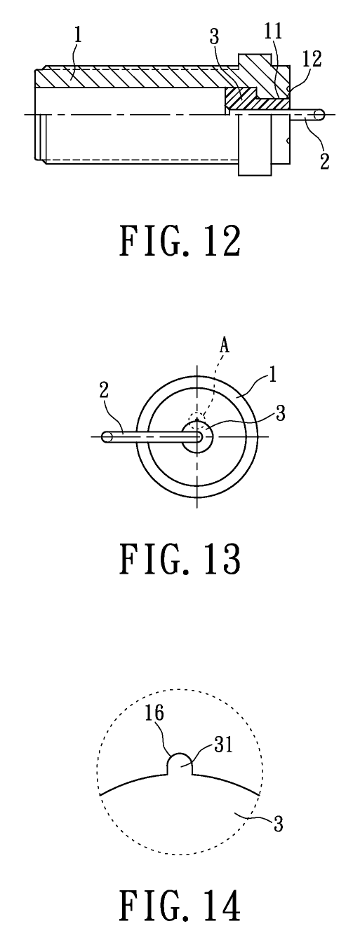

Please referring to FIG. 9 to FIG. 12 for more preferred embodiments illustrations. These preferred embodiments demonstrate dot-indent fastening methods. When the telecommunication connector is installed onto the RF can or after the secondary processes (such as soldering or other processes) of the RF can with telecommunication connector(s) installed, one or multiple dot indents 14 (as shown in FIG. 10) and 15 (as shown in FIG. 11) is formed on the rear end surface of the grounding body 1 around the rear round hole 11 with punching, pressing, or other methods. Dot indent 14 and 15 provide the same function to enhance mechanism 12 to fix rear end insulator 3 more firmly in the rear round hole 11 of the grounding body 1. Thus, the central pin 2 is further firmly fixed in the grounding body 1.

In addition, the number, shape, depth, and positions of dot indent 14 and 15, and the pressure of punching or pressing processes can be adjusted according to different materials and various designs of the grounding body 1 and the rear end insulator 3. For example, the dot indents 14 are round but the dot indents 15 are arch. The inner radius of the dot indents 14, 15 will be concentricity or may remain significantly concentric with the mechanism 12 and the center pin 2. It depends on the requirements of telecommunication connectors and the different materials and various designs of the grounding body 1 and the rear end insulator 3.

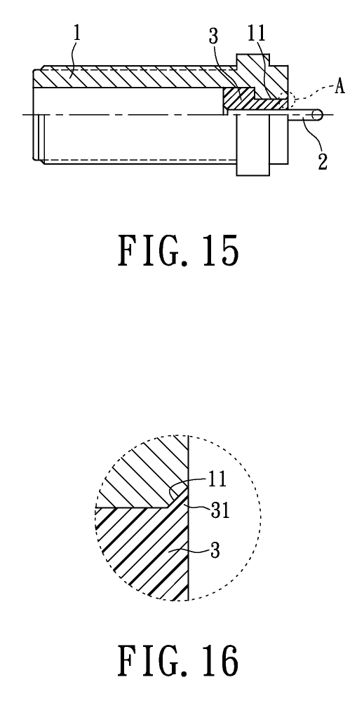

As illustrated in FIG. 13 to FIG. 16, a tiny fixing pin 31 is built on the edge of outer surface of the rear end insulator 3. A small notch 16 is made on the rear end surface of the grounding body 1. This small notch 16 will fit the tiny fixing pin 31 well because the size of notch 16 is just slight smaller than the size of the tiny fixing pin 31. For instance, the size of the small notch 16 is about, say, 0.08 mm (length)×0.05 mm (width)×0.1 mm (height) or less, but the associated dimensions of the fixing pin 31 is about 0.10 mm (length)×0.07 mm (width)×0.12 mm (height) or a little bit larger. The quality of telecommunication signal would not be affected by the tiny notch 16 and the tiny fixing pin 31. The tiny fixing pin 31 can be of bar-shape, cone-shape, semi-sphere-shape, or other shapes.

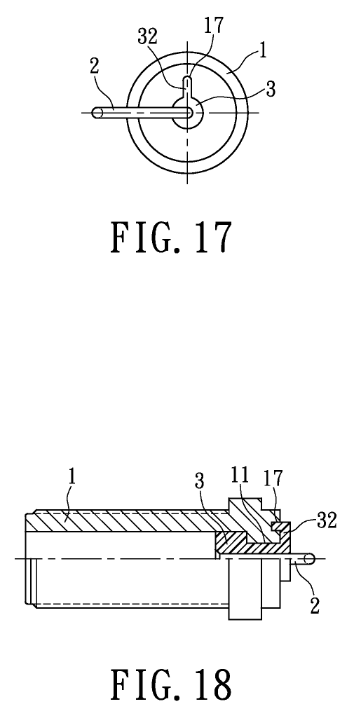

Referring to FIG. 17 to FIG. 18 now, a plug 32 is made on the rear side of the rear end insulator 3. A blind hole 17 is made on the rear end of grounding body 1 for plug 32 to fit in. The plug 32 is installed into blind hole 17 tightly so that the center pin 2 and the rear end insulator 3 is fixed in the grounding body 1 firmly. The number of plug 32 and the associate blind hole 17 is not limited, and the shapes and designs of plug 32 and the associate blind hole 17 can be changed accordingly. It is not necessary to make plug 32 to be of the same shape of hole 17 as long as these devices provide the function to hold the center pin 2 firmly at needed locations.

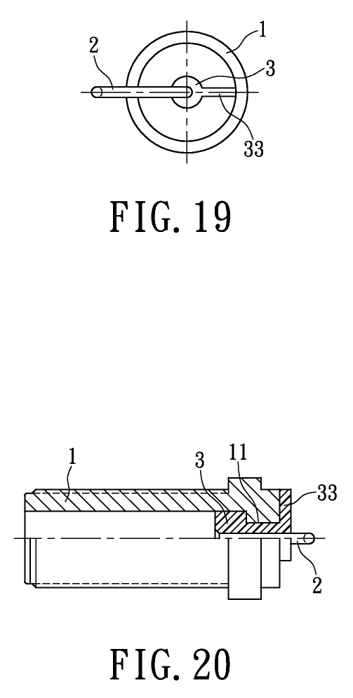

Lastly, please referring to FIG. 19 to FIG. 20, an alignment bar 33 is built on the rear end insulator 3. When the rear end insulator 3 with the center pin 2 is loose or can be rotated in ground body 1, the alignment bar 33 can be used to rotate to the right position without any physical or manual contact to the center pin 2 during the adjustment of the loose center pin 2. As a result, the risk of damaging center pin 2 could be avoided.

Additionally, the product life of center pin 2 will be increased because no foreign materials will be attached on center pin 2 during manual alignment adjustment. A tiny shallow indent or groove can be made on the rear end surface of the grounding body 1 as a guide mark for better alignment and fitting function of the alignment bar.

The present invention provides many advantages. Some of them are listed as follows.

1. The precision control of the grounding body and the insulator can be reduced. The tooling manufacturing and maintenance cost can be reduced, but the yield rate of good throughput will be increased.

2. The sorting and manual adjustment cost of the center pin can be reduced, and the assembly time of the tuner module (RF can installed with telecommunication connecter) and the circuit board can be reduced so that the good yield rate of circuit board assembly will be increased. Moreover, since the center pin will not be touched during adjustment, the center pin will not be distorted and will not get oxidized in a relatively short period of time.

3. Because the center pin is firmly fixed in the grounding body and the grounding body is installed on the RF can tightly as well, the center pin will not become loose or even fall off from the other connector components easily during the operations of the consumers. Thus, the risk and cost of calling back final products from the market will be avoided and the reputation of RF can manufacturers, telecommunication connector manufacturers, and the buyers who purchase these components for their final products will be well protected.

4. The present invention can be applied to F connectors, PAL connectors, and other similar connectors in order to improve the issues of loose center pin, regardless how the ground body, insulator, and center pin are built.

The demonstrations and examples above are merely some preferred embodiments of the present invention. It will be understood that the present invention is not limited to the described details thereof. Various substitutions and modifications have been suggested in the foregoing descriptions. While the specific embodiments of the invention have been disclosed, it will be appreciated by those skilled in the art that various modifications and alterations to those details could be developed in light of the overall teachings of the disclosure. Accordingly, the particular arrangements disclosed are meant to be illustrative only but are not to limit the scope of the present invention, which is to be given the full breadth of the appended claims and any and all equivalents thereof.

What is claimed is:

1. An improved mechanism applied to a telecommunication connector, comprising:
a grounding body of a hollow housing, wherein a round through hole passes along the center line of the housing, the radii of the round through hole at each end of the grounding body can be different from the other;
an insulator holding a center pin is installed at the rear end hole of the grounding body, wherein the center pin held at the center of the insulator located along the center line of the through hole of the grounding body after the insulator and center pin have been installed into the rear end hole of the grounding body, which functions as a preliminary mechanism holding the insulator and the center pin tightly; and
at least one indent groove of annularity or other geometric shapes is formed on the rear end surface of the grounding body to firmly assemble the insulator and center pin into the grounding body.

2. The improved mechanism as claimed in claim 1, wherein the mechanism is annular.

3. The improved mechanism as claimed in claim 1, wherein the mechanism is slightly and evenly protruded onwards the center of insulator and is slightly and evenly indented at the rear end of the inner wall of the grounding body.

4. The improved mechanism as claimed in claim 1, wherein an alignment bar on the insulator provided for alignment correction and fixing enhancement.

5. An improved mechanism applied to a telecommunication connector, comprising:
a grounding body of a hollow housing, wherein a round through hole passes along the center line of the housing, the radii of the round through hole at each end of the grounding body can be different from the other;
an insulator holding the center pin is installed at the rear end hole of the grounding body;
a center pin held at the center of the insulator located along the center line of the through hole of the grounding body after the insulator and center pin have been installed into the rear end hole of the grounding body, wherein the rear end hole of the grounding body functions as a preliminary mechanism holding the insulator and the center pin tightly; and
at least one dot indents on the rear end surface of the grounding body enhances the firmness of the mechanism abutting against the insulator and the center pin.

6. The improved mechanism as claimed in claim 5, wherein the mechanism is annular.

7. The improved mechanism as claimed in claim 5, wherein the mechanism is slightly and evenly protruded onwards the center of insulator and is slightly and evenly indented at the rear end of the inner wall of the grounding body.

8. The improved mechanism as claimed in claim 5, wherein an alignment device, such as an alignment bar, is on the insulator.

9. An improved mechanism applied to a communication connector, comprising:
a grounding body of a hollow housing, wherein a round through hole passes along the center line of the housing; the radii of the round through hole at each end of the grounding body can be different from the other;
an insulator holding a center pin is installed at the rear end hole of the grounding body, wherein the center pin held at the center of the insulator located along the center line of the through hole of the grounding body after the insulator and center pin have been installed into the rear end hole of the grounding body; and
at least one plug on the insulator corresponding to at least one associate blind hole on the rear end surface of the grounding body.

10. The improved mechanism as claimed in claim 9, wherein the plug is a protrusion mechanism.

11. The improved mechanism as claimed in claim 9, wherein the blind hole is a concave hole or a geometric indentation.

12. The improved mechanism as claimed in claim 9, wherein the blind hole is a tiny notch at the inner wall of the end opening of the through hole of the grounding body, the plug is a tiny protrusion mechanism fitting into the tiny notch.

13. The improved mechanism as claimed in claim 9, wherein the number of plugs and blind holes can be more than one; at least one plug fits the associate blind hole well and tightly; and none of the blind holes and the associate plugs is mechanically conflict against each other.

14. The improved mechanism as claimed in claim 9, wherein an alignment device, such as an alignment bar, is on the insulator.
